(19) United States
(12) Patent Application Publication
(10) Pub. No.: US 2013/0110540 A1
(43) Pub. Date: May 2, 2013

(54) Method of Collecting Patient Information in an Electronic System

(71) Applicant: Glenn Mitchel Kimberling, Cypress, TX (US)

(72) Inventor: Glenn Mitchel Kimberling, Cypress, TX (US)

(73) Assignee: Patient Identification Network LLC, Cypress, TX (US)

(21) Appl. No.: 13/282,353

(22) Filed: Oct. 26, 2011

(51) Int. Cl. G06Q 50/24; G06Q 30/02; G06Q 50/22

(52) U.S. Cl. 705/3; 705/2; 705/14.53

(57) ABSTRACT

A method of collecting patient information in an electronic system which eliminates the need to handwrite the patient information sheet, which exist in most doctor's offices. Patients complete their information on a secure website and the data is stored in either a remote or local database. The patient is issued two types of identification numbers or other type of authentication information. The first is used by the patient to update and view the information, and the second is provided to the doctor's office so they can download information about the patient without the need for patient information sheets.

### BACKGROUND OF THE INVENTION

Almost every trip to a doctor's office is accompanied by paperwork. The doctor wants to ensure their records are complete both for billing and for treatment purposes. The doctors need a complete medical history for a patient to allow for an accurate diagnoses and treatment. Medicines and treatments to be prescribed by the doctor may have been tried by previous physicians. Medicines have side effects which could be the root cause of a current aliment.

But many patients find this paperwork to be a nuisance, especially when they see the same doctor on a regular basis. Handwriting the information is a tedious task. Further, some patients may not remember all the information the doctor is requesting. Some details may escape the patient's memory, such as: the exact dates of surgery, the names and dosages of medicines currently being taken, and addresses of other doctors who may have treated the patient.

Medical providers have attempted to address the above problems by allowing patients to enter medical information directly into the healthcare provider's database. But most doctor's dislike such a solution because any access to a system is a potential point for improper release of information for which the doctor is liable. Patients do not like such systems because they are not standardized from one medical provider to another, and duplicate information must be entered into each medical provider's unique system.

Insurance companies have secure communication channels with doctors and other health care providers. They have displayed intentions of leveraging these secure channels by providing a system for doctors to use in sharing information regarding common patients. Insurance companies attempt to gather all the information regarding a patient into a single database which all doctors can access and update. Patients distrust these systems because they feel insurance companies may use such information to raise insurance rate, or to drop customer policies, or to look for discrepancies on which to deny coverage of a claim. Further, such systems give doctors more information than is necessary for accurate diagnoses, which is an unnecessary invasion of patient privacy. Finally, a large concern for much of the general public is that they no longer have control over their medical information if they leave it in the hands of someone else. If there are mistakes, it is difficult to have them removed or corrected. Further corrected entries made later in a chart may not be reviewed or correctly associated with the earlier incorrect information. Such wrong information in a medical file can cause additional costly test to be ordered, or higher premiums on a policy, or worst, mistreatment of ailments.

In this description the person utilizing the system to store and retrieve their personal information may be referred to as the patient. This term is clearly meant to include the actual patient who is utilizing the system to store his or her own information. The term also can be used to include a person who is utilizing the system to store information for another, such as a parent utilizing the system on behalf of a child, or a caretaker utilizing the system on behalf of their charge.

In this description the term doctor is used to describe anyone who uses the system to retrieve and update information on a patient in connection with utilizing the system to render health care. The term doctor is all inclusive of any healthcare professionals including the doctor, his or her staff, including nurses, practitioners, technicians, etc. whom access the system on behalf of or in the course of their duties with the doctor. Further, this term can include pharmacist, radiologist, etc. participating in the patient's care and their staff.

### BRIEF DESCRIPTION OF THE DRAWINGS

FIG. 1 illustrates a flowchart of a typical sequence of actions of a patient in interacting with a patient information system implemented in accordance with an exemplary embodiment of the invention.

FIG. 2 illustrates a flowchart of a typical sequence of actions of a patient in interacting with a patient information system implemented in accordance with an exemplary embodiment of the invention.

FIG. 3 shows a diagram of the flow of information in a patient information system implemented in accordance with an exemplary embodiment of the invention.

FIG. 4 illustrates a flowchart of a typical sequence of actions of a healthcare professional in interacting with a patient information system implemented in accordance with an exemplary embodiment of the inventor.

### DETAILED DESCRIPTION OF THE PREFERRED EMBODIMENTS

When a patient goes to a healthcare professional, the first thing they are often confronted with is a series of questionnaires of personal information and medical history. Even when a person is a regular long-term patient, they are often required to review and complete information sheets, provide updated address and insurance information, and describe recent symptoms. All of this is usually on handwritten forms.

If a patient is new to the facility, they are expected to recall names of doctors they may have seen many years ago, or to remember surgeries and recall dates of treatment and illness onsets. Patients are queried about dosages of medications which they routinely take. But, many patients may only generally refer to these medications by a colloquial name (e.g. “heartburn medication”) or descriptive name (e.g. “the large green capsules”), and may not know the actual dosages. The recent push of generic substitution for many pain meds further complicates the issue because there are now multiple names for the same medication. Further, since most these forms are handwritten, and provide limited space for answers, the information collect is not always complete or accurate. Further illegible handwriting can also lead to errors in transcription into the patient's electronic record.

Since many doctor's offices tend to be congregated in certain areas of town, patients will often take advantage of the opportunity to handle several medical issues at one time by scheduling multiple appointments for the same day. A patient with multiple doctor visits must provide the same information over and over at each office. Many patients would like the opportunity to complete this information ahead of time to ease the stress and time required for the medical visits.

By completing questionnaires at home, the patient has easier access to their personal records ensuring that information is more complete and accurate. Completing the questionnaires in an electronic format ensure that the information is legible (i.e. handwriting is not an issue). Some systems have been developed to provided access for patients to enter information straight into the healthcare professional's database either in the office through an onsite computer, or through a remote access feature. Doctor's have shown an apprehension to using this type of system because it provides an access medium which can be compromised by hackers to reveal sensitive patient information. Insurance carriers, who have secure methods for communicating with healthcare professionals, have attempted to gather and share the patient information across the network. Patients are leery of the insurance companies' motives in keeping the large databases. These large databases can be used to increase insurance rates, or ascertain inconsistencies, intentional or unintentional, which may be used to deny a claim. Patients in general are hesitant to have all their information gathered into a single database in which they do not have control because of the improper use that may occur, the security issues, and the difficulty in getting others to correct information which the patient believes is mistaken, or to delete information the patient wants to remain private.

Described herein is a system of collecting patient information at the patient's convenience and providing that information to a plurality of doctors only when and how the patient chooses to disperse such information. The system utilizes authenticated access and encryption to protect sensitive information. All information is encrypted by an asymmetric cipher or a dual-key crypto system. A dual key system ensures that only the patient, who possesses the primary key, can add information into the database such that the information is available for discrimination to other health care professionals (HCP) so the patient may maintain control of what information is included. The secondary key is shared with a healthcare professional to allow access to patient information in the database, and to provide updates back to the database, which must be viewed and approved by the patient before the primary key can be used as information to be discriminated to the public. In another embodiment the system may utilize an identification card for access control, or a numeric control code which is provided to the doctor's office upon arrival for a visit, or which may be entered by the patient. The identification card has a patient unique identification number, which may be computer generated. The system utilizes a card reader, number, and/or signature pad. The pads and cards may be of the current types readily available in the general market for secure access to electronic systems.

In the preferred embodiment, a patient would create an account with a service for storing their personal information in an encrypted format. The service could be implemented as a secure website which stores information in an encrypted database. In one embodiment the database may be a central database located on the server of the service provider. In another embodiment each user may designate a machine under their control on which the database is maintained as a local database. In such an embodiment the machine hosting the database may run a service which facilitates remote connection with the service when data is accessed by a healthcare professional through the service. The distributed database information would be less of a target for hackers and other illicit access because of the limited information in the local database.

In another embodiment, the database may be split between a local database and a remote database with information stored in one or both locations depending on user preferences, sensitivity of the information, or other characteristics. In another embodiment complete information may be stored in one database, and transferred to or from another database based on the desire of the patient to discriminate the information to one or more HCPs.

The information collected by the system is the general information and medical history which most healthcare providers require of their patients. Examples of general information would include, but not be limited to name, address, insurance carrier and policy information, employer, occupation, etc. Examples of medical history would include, but not be limited to family medical history, past surgeries and illnesses, symptoms, prescriptions, over-the-counter medicines regularly taken, current symptoms, etc.

Doctors who subscribe to the service could also provide a list of additional custom queries they would like their patients to answer. A patient or potential patient could identify their regular doctors, or those doctors they intend to see. The system would then identify the custom questions of those healthcare professionals and update the database appropriately.

A doctor using the service would start by selecting from several standard questionnaires provided by the service depending on the types of service the doctor offers. The doctor could also specify additional questions they would like their patients to answer. The questions could be open ended questions or may be multiple-choice, fill in the blank, or true/false in format. The doctor would then specify how they wanted the patient information delivered to their office. It could be delivered in electronic format or hardcopy format. Electronic information delivery may be, but is not limited to the following: comma delimited format, XML (eXtensible Markup Language) format, tab delimited, or a custom database field format. Hardcopy format can be, but is not limited to paper forms which are printed at the doctor's office, fax delivered from the system, or emailed in PDF (Portable Document Format) formats. Additionally, the patient could print the forms from their personal system and deliver them to the doctor's office in paper format. The patient could also download the documents in electronic format and deliver them to the doctor's office via an electronic transfer medium such as email, a thumb-drive, and/or a Universal Serial Bus (USB) device. Further, printed forms may be formatted for OCR (Optical Character Recognition), OMR (Optical Mark Recognition), Bar-coded entry, etc.

A doctor, having registered with the service and completing the steps above, could then send patients an email when they register for appointments requesting that they join the service and complete the information online before coming to the office for their appointment. Regular patients of the doctor could receive reminders to update their medical profiles before a scheduled visit.

A doctor who does not regularly participate in the service could use web access to login to the system with the key provided by the patient and download or print the medical information in one of the pre-prepared information forms the system offers for doctors' use. The doctor's office would then be given the opportunity to become a subscriber of the service, or to download the single patient's information from the system.

A typical process involves a patient signing up for the system's service and filling out the required information, which is the standard information given at almost every doctor's office. At some point in the process the patient is given a unique identification number and is required to choose a password. For patients unaware of the system, the doctor's office may choose to give the patient a card, letter, or other notice directing them to the website, or provide them with access to a computer where they can register for the service. This could be done while the patient waits for their appointment. The doctor's offices have a subscription to the service which will include access to the patient data accessible when the patient shares a private access code with the doctor's office. In addition to saving the doctor's office time and money handling traditional paper forms and transcribing data to electronic format, it will also save patients time and frustration of filling out information sheets.

The doctors may pay a subscription which allows them to download a prescribed number of patient records, or they may pay a per download fee for each record accessed. There are several other methods which could be used to commoditize the system including but not limited to an advertising based revenue stream which advertises to either or both the doctors' offices and to the patient. Another embodiment may allow patients to complete symptoms and the system makes basic diagnoses of the symptoms to recommend the type of doctor to handle the ailment. Such recommendations could be based on other patient ratings, proximity to the patient, paid subscriptions, or other rankings In such a system doctors in certain areas may pay to have their offices listed higher in the list of recommended doctors. Over the counter medicines may be advertised as methods of relieving symptoms before visiting the doctor's office. Prescription medications may be advertised to the doctor as possible treatment recommendations.

Upon entering the doctor's office the staff ask the patient to sign in and provide there identification number if they are a registered user of the system. Once the identification number is provided, the doctor's office has access to the patient's information and may have the ability to print the information to a hardcopy, or to store the information digitally. After a patient visit is completed, the doctor's office may provide details of the visit back to the patient using the same identification number. The patient will receive a notification that the doctor has uploaded information. The patient will then have the opportunity to review the information and determine if they want to add it to their database of medical information. The information provided by the doctor's office after a patient visit may include, but is not limited to the following: vitals (such as height, weight, blood pressure, glucose levels, heart rate), test results, diagnoses, medications prescribed and dosages, overall impressions, referrals to specialist, dietary recommendations, etc.

Further, the patient may be provided the opportunity to rate the doctor's office. Such rating may include, but are not limited to wait time, efficiently, bed-side manner, warmth, accuracy of diagnoses, compassion, relatability, etc. Ratings would be provided back to the HCP on a monthly basis as aggregated values to protect patient annominity and encourage truthfulness.

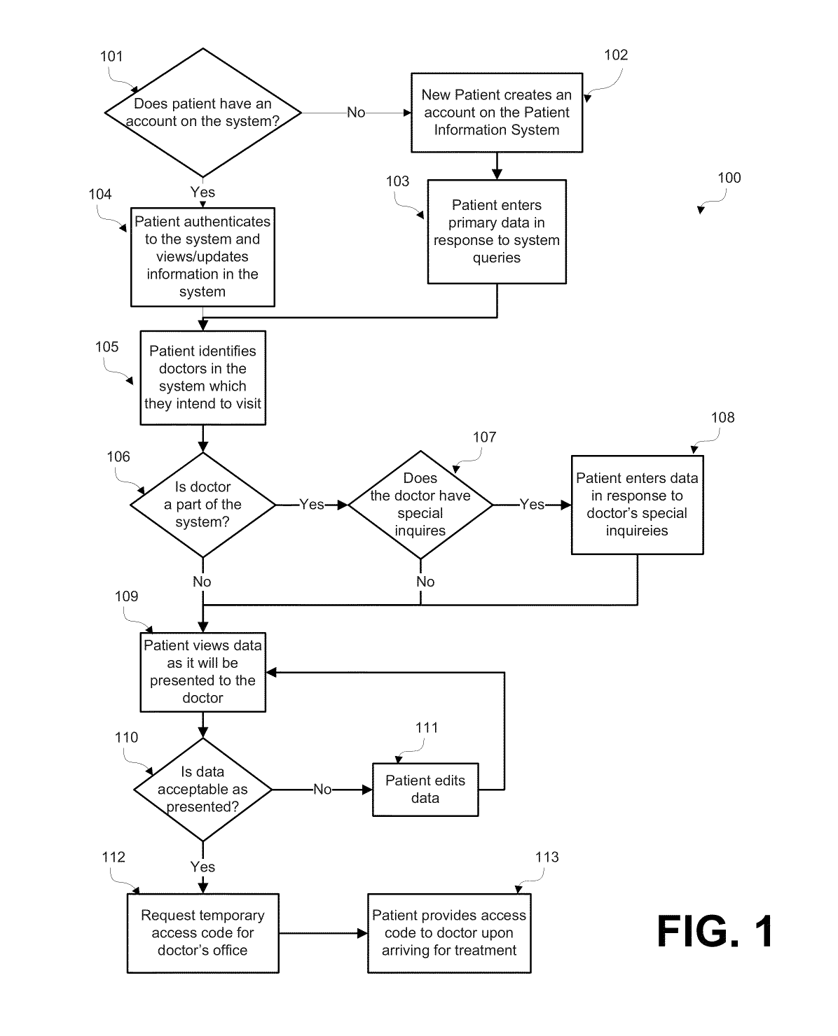

FIG. 1 illustrates a flowchart of typical sequence of actions of a patient in interacting with a patient information system implemented in accordance with an exemplary embodiment of the invention. First in the flowchart (100) the patient must decide if they have an account already created on the system (101). If the patient does not have an account then the new patient creates an account on the patient information system (102). The patient then enters primary data in response to system queries (103). These system queries can be standard fill in the blanks, multiple choice, radio buttons, check boxes, etc.

If a patient already has an account on the system (101) then the patient authenticates to the system and view/updates information on the system (104). Authentication can be in the form of a username/password, or a code, or a security device such as a crypto key, swipe card, and/or biometric data. The patient identifies doctors in the system which they intend to visit (105). If the doctor is a part of the system (106), that is they are registered and created a profile on the system, then the system will check to see if the doctor has any special inquires or queries (107) that they would like to use to gather information from potential patients. If so, then the patient enters the data in response to the doctor's special inquires/queries (108).

Next the patient can view all data in the system. Specifically the patient can view data in the forms chosen by the doctors they are intending to see and view the data as is will be presented to the doctor (109). If the data to be presented to the doctor is not acceptable (110), then the patient is given an opportunity to edit the data (111). Once the data is acceptable as it will be presented to the doctor (110), the patient may request a temporary access code for the doctor's office (112) to use in accessing the system (113). This temporary access code may be a for example, a numeric key, a password, or a crypto key. The temporary access code may be time limited and/or may be limited to use for a specific doctor, and/or may be limited for use in viewing a specific form.

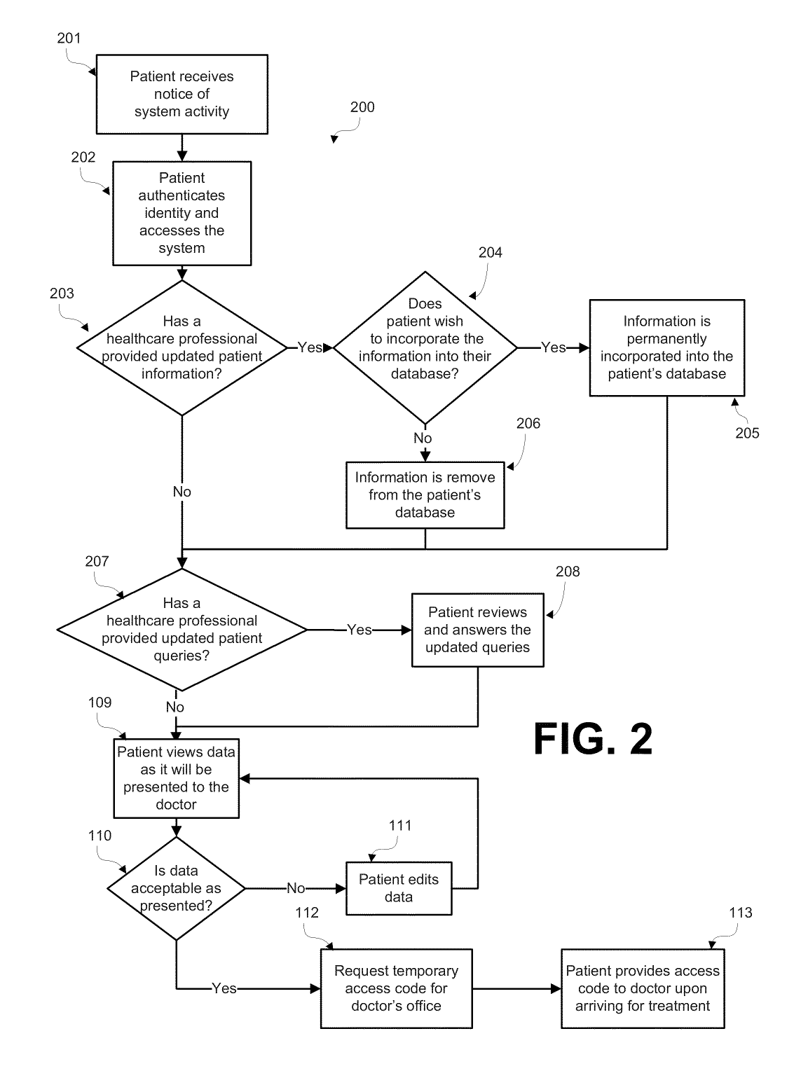

FIG. 2 illustrates a flowchart of a typical sequence of actions of a patient in interacting with a patient information system implemented in accordance with an exemplary embodiment of the invention. On periodic basis, such as when a patient has scheduled an appointment with a doctor who used the patient information system, or when data in the system needs to be updated, the patient will need to return to the system to respond to new queries, or update their information. The process for doing this is illustrated in the flowchart (200). First a patient will receive a notice of system activity (201). Such a notice can be sent by a doctor scheduling an appointment for a patient whom is known to be a system user, or may be a periodic updates which are automatically sent by the system in an attempt to ensure patient data is kept up to date. When a patient receives notice of system activity (201), the patient may log onto the system by authenticating their identity to the system (202). The system will then check if there is temporary data that has been uploaded by one of the patient's healthcare professionals (203) in response to a recent visit. If new data exist, then the patient has the opportunity to review the data and determine if they wish to incorporate it in with their existing data (204). If the patient wishes to incorporate the data, then the data is permanently included with the patient's regular data (205). The patient also has the option of rejecting the data in which case it is removed from the database (206). Next the system will check if a healthcare professional, whom the patient has indicated as one of their doctors, has provided any updated patient queries (207). If so, then the patient may review and answer the updated queries (208) so the data is available for the next visit to that healthcare provider.

As before, the patient can view all data in the system. Specifically the patient can view data in the forms chosen by the doctors they are intending to see and view the data as is will be presented to the doctor (109). If the data to be presented to the doctor is not acceptable (110), then the patient is given an opportunity to edit the data (111). Once the data is acceptable as it will be presented to the doctor (110), the patient may request a temporary access code for the doctor's office (112) to use in accessing the system (113). This temporary access code may be a for example, a numeric key, a password, or a crypto key. The temporary access code may be time limited and/or may be limited to use for a specific doctor, and/or may be limited for use in viewing a specific form.

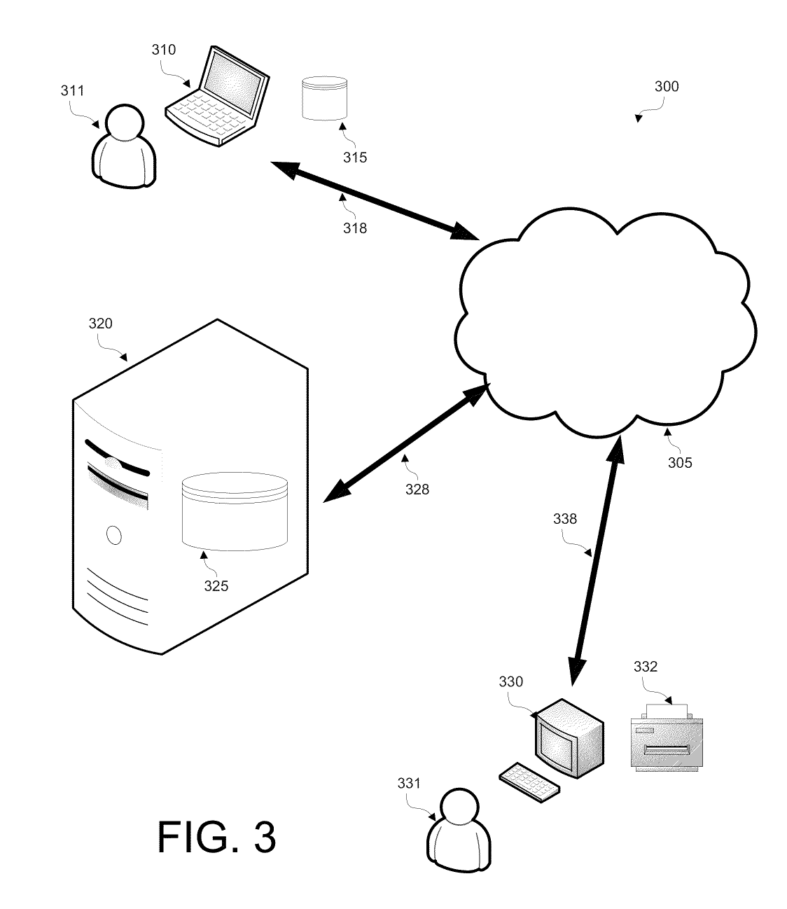

FIG. 3 shows a diagram of the flow of information in a patient information system implemented in accordance with an exemplary embodiment of the invention. In this diagram (300), the user (311) uses a terminal (310) to send and receive information (318) through the Internet (305) or some other network. Data from the patient may be stored on a local database (315) on the user's machine (310), or on a remote database (325) such as one stored on the server (320) which runs the patient information system. A healthcare professional (331) uses a computer (330) in their office to send and receive data (338) through the Internet (305) or some other network. When a healthcare professional (331) uploads temporary data regarding a patient, that information is sent (328) to the server's (320) database (325) for temporary storage until it is accepted by the patient (311) and incorporated into their permanent data, which may be stored on a local database (315) or on a remote database (325).

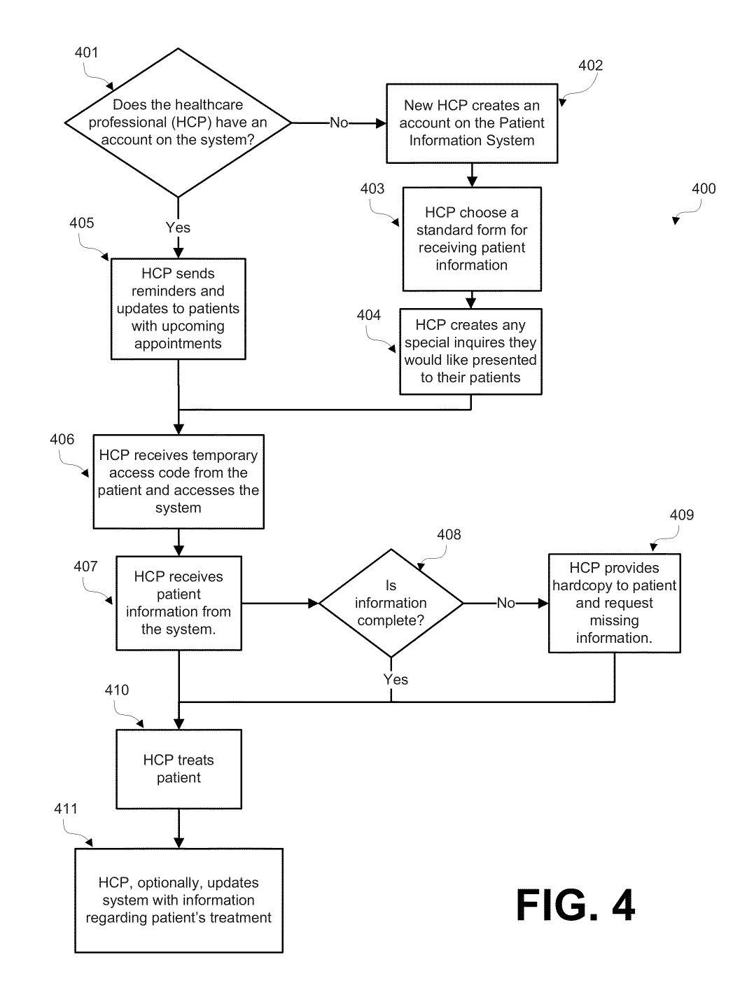

FIG. 4 illustrates a flowchart of a typical sequence of actions of a healthcare professional in interacting with a patient information system implemented in accordance with an exemplary embodiment of the invention. The actions of a healthcare professional (HCP) are illustrated in the flowchart (400). If a HCP does not have an account with the system (401) then the new HCP creates an account with the patient information system (402). Part of creating the account, beyond the obvious creating authentication credentials, is for the HCP to choose a standard form for receiving patient information (403). This form will depend on the type of practice and type of patient the HCP is treating. The HCP may then create any unique queries (404) they would like to use to gather information from their patients. In one embodiment, the HCP may create custom forms rather than using one of the existing forms available in the system.

An HCP may use the system to send reminders and updates to patients with upcoming appointments (405). When a patient comes to the office for a visit, they will provide the HCP with a temporary access code (406). The HCP uses the access code to receive the patient information from the system (407). If the information from the system is not complete (408), then the HCP may print the data on a hardcopy form and provide the form to the patient to request the missing information (409).

Once the HCP treats the patient (410), they have the option to provide updated information to the system (411) regarding that treatment (410). The information provide may be the vitals that were observed during the visit, any diagnoses, prescriptions, etc. which a patient may use to keep their personal information up to date. As illustrated on FIG. 2, the patient will have the opportunity to review this information and choose if they would like to have it incorporated into their information.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for collecting patient information comprising;
providing a patient authenticated access to an electronic system;
collecting from the patient medical history and other general information;
storing the information in an electronic format.

2. A method for collecting patient information as described in claim 1 further comprising:
providing a healthcare professional authenticated access to the electronic system to access the information stored in electronic format.

3. A method for collecting patient information as described in claim 1 wherein:
the electronic system comprises a secure website interface to a database.

4. A method for collecting patient information as described in claim 1 wherein:
authenticated access is provided by a secret alpha, alphanumeric, or numeric code shared by the patient and the electronic system.

5. A method for collecting patient information as described in claim 4 wherein:
the secret code is further utilized to encrypt the data in the database.

6. A method for collecting patient information as described in claim 4 wherein:
the patient request and is issued a temporary secret code for accessing the encrypted data which is to be shared with a healthcare professional.

7. A method for collecting patient information as described in claim 6 wherein:
the secret code is valid only for one-time use.

8. A method for collecting patient information as described in claim 6 wherein:
the secret code is valid only for a limited time-frame.

9. A method for collecting patient information as described in claim 6 wherein:
the secret code does not allow editing or updating of the patient information.

10. A method for collecting patient information as described in claim 1 further comprising:
accessing patient information comprising; utilizing an authenticated access to an electronic system to access medical history and other general information provided by a patient in electronic format.

11. A method for collecting patient information as described in claim 10 further comprising:
providing updated medical history information regarding recent treatment for the patient to include into the database.

12. A method for collecting patient information as described in claim 11 further comprising:
providing the patient notice of the presence of updated medical history information regarding recent treatment for the patient to accept or reject for inclusion into the database.

13. A method of collecting patient information as described in claim 10 wherein the information is presented in one of a plurality of formats selected by the healthcare professional.

14. A method of collecting patient information as described in claim 10 wherein the information is presented in a format customizable by the healthcare professional.

15. A method of collecting patient information as described in claim 10 wherein the healthcare professional may send request for additional information to the patient through the system either before or after a visit.

16. A method of targeting advertising to healthcare professionals and consumers comprising:
producing targeted ads for medical services based on the type of doctors, the medicines, or illnesses in a patient's medical information.

17. A method of targeting advertising to healthcare professionals and consumers comprising:
producing targeted ads for medical services based on the type of patients a doctors office accesses medical records for.
